(19) United States
(12) Patent Application Publication
(10) Pub. No.: US 2005/0189239 A1
(43) Pub. Date: Sep. 1, 2005

(54) Advanced dual sensor technology for a continuous emission monitoring system

(75) Inventors: John Ellis, Sheffield (GB); Richard E. Whiteside, Derbyshire (GB); Richard A. Hovan, Doylestown, PA (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: Land Instruments International, Inc., Newtown, PA (US)

(21) Appl. No.: 10/823,329

(22) Filed: Apr. 13, 2004

Related U.S. Application Data
(60) Provisional application No. 60/547,910, filed on Feb. 26, 2004.

(51) Int. Cl. G01N 27/26

(52) U.S. Cl. 205/780.5; 204/408; 205/782; 204/424

(57) ABSTRACT

A system and method for providing continuous emission data of stack flue gas using at least one pair of electrochemical (EC) cells that are switched between flue gas flow and air.

### 5 BACKGROUND OF THE INVENTION

1. Field of Invention

This invention relates to gas detection, and more particularly, to continuous gas detection of stack emissions.

2. Description of Related Art

Since the inception of the EPA and the need for compliance monitoring with predetermined performance specifications, the industry has looked for new technologies that could provide high accuracy values with a low cost. Currently, chemiluminescent sensors are used to detect NO, pulsed fluorescence sensors are used to detect SO₂, gas filter correlation is used to detect CO and paramagnetic and zirconia oxide sensors are used to detect O₂. However, the use of such sensors is not only very expensive, but they are high maintenance devices and require the customer to implement calibration procedures to maintain these devices within operating requirements; in addition, these devices cannot provide accurate measurements of concentrations below 10 ppm.

In a mandate to the EPA, new, low cost alternative monitoring techniques now must be reviewed and addressed. Electrochemical cell technology has been available for the last 15 years; however, until recently, a technology using electrochemical cells for low level values has not been available. In addition, electrochemical cells which are run continuously suffer from drift and loss of sensitivity, and this makes them unsuitable for use where high accuracy is needed. Moreover, EPA regulations for flue gas emissions monitoring are requiring increasing accuracy and stability at ever lower pollutant levels.

Thus, there remains a need for a continuous emission detection system that operates with high reliability, high accuracy and low maintenance costs using electrochemical cells.

All references cited herein are incorporated herein by reference in their entireties.

### BRIEF SUMMARY OF THE INVENTION

An emissions monitoring system for continuously monitoring the level of component gases in flue gas, said system comprising: a temperature-controlled sensor module; at least two electrochemical sensors for measuring the level of a predetermined component gas, wherein the at least two electrochemical sensors are disposed in the temperature-controlled sensor module; valves for directing the flow of flue gas and air to the at least two electrochemical sensors; a controller for controlling the valves such that the at least two electrochemical sensors are alternately exposed to the flue gas and to air wherein one of the at least two electrochemical sensors is providing a measurement of the concentration of the predetermined component gas and another one of the at least two electrochemical sensors is recalibrated with reference to clean ambient air.

A sensor assembly for continuously detecting the level of component gases in flue gas, wherein the sensor assembly comprises: a temperature-controlled sensor module; at least two electrochemical sensors for measuring the concentration of a predetermined component gas, wherein the at least two electrochemical sensors are disposed in the temperature-controlled sensor module and are alternately exposed to the flue gas and to air so that one of the at least two electrochemical sensors is providing a level of the predetermined component gas and another one of the at least two electrochemical sensors is recalibrated with reference to clean ambient air.

A method for continuously monitoring the concentration of component gases in flue gas, wherein the method comprises the steps of: providing at least two electrochemical sensors for measuring the concentration of a predetermined component gas; and alternately exposing one of the at least two electrochemical sensors to the flue gas and another one of the at least two electrochemical sensors to air.

### BRIEF DESCRIPTION OF SEVERAL VIEWS OF THE DRAWINGS

The invention will be described in conjunction with the following drawings in which like reference numerals designate like elements and wherein:

FIG. 1 is a block diagram of the present invention showing a continuous emission detection system using a dual gas sensor configuration;

FIG. 2 is a timing diagram depicting how each sensor in the sensor pair is alternately exposed to flue gas and air;

FIGS. 3A-3B form a flow diagram of the system controller operation;

FIG. 4 is an isometric view of the temperature-controlled sensor module with the sensor access door opened and with the respective sensor circuit cards not shown;

FIG. 5 is a top view of the temperature-controlled sensor module and the thermoelectric heating/cooling unit coupled thereto; and

FIG. 6 is a side view of an electrochemical (EC) cell showing how it is mechanically coupled within the temperature-controlled sensor module and electrically-coupled to the system controller.

### DETAILED DESCRIPTION OF THE INVENTION

The present invention improves on the traditional technologies for flue gas measurement by taking advantage of the high reliability, high accuracy, and low maintenance costs made possible by modern electrochemical cells. The present invention benefits from an inherent low level measurement capability, often beyond the range of traditional technologies. The present invention forms a proven low-cost, high accuracy, low level analyzer system using advanced dual electrochemical sensor technology (ADST) that meets all current and proposed NOₓ, (NO+NO₂), CO, and SO₂ rules for low level values as well as O₂ for diluent measurements.

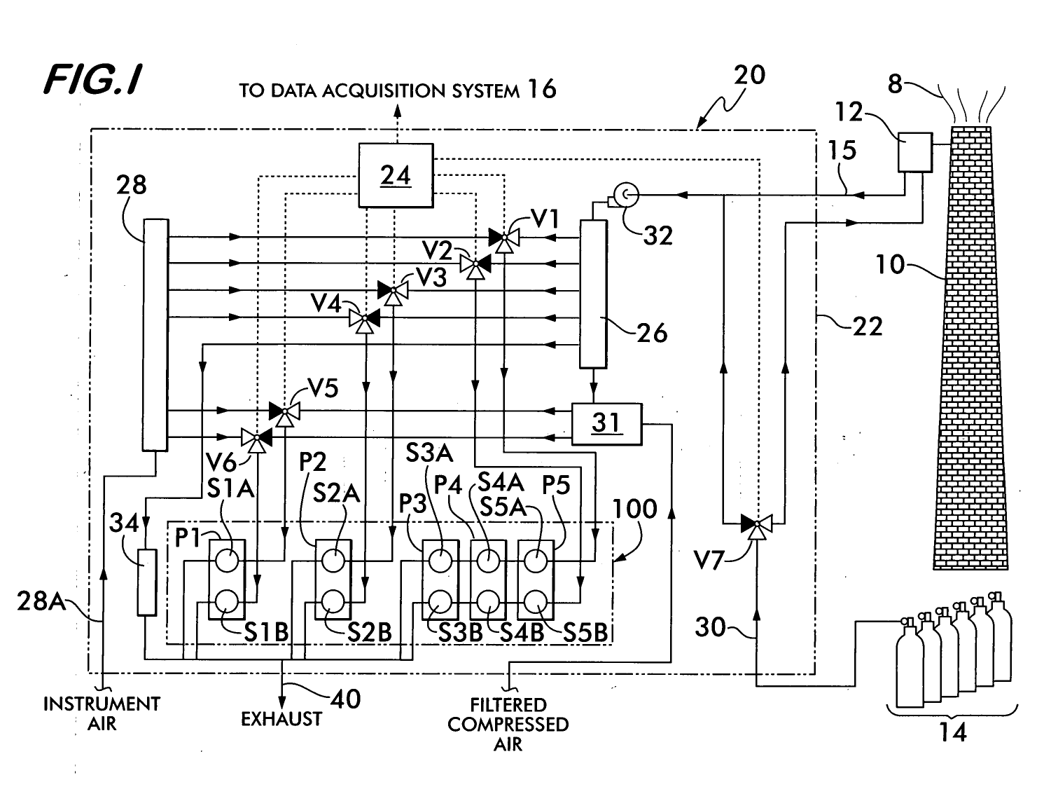

As shown in FIG. 1, the present invention comprises an emissions monitoring system 20 for continuously monitoring the concentrations of component gases in flue gas 8 in a stack 10 using a temperature-controlled sensor module 100. This multi-gas analyzer system 20 comprises an enclosure 22 that houses the system components. The system 20 basically comprises a system controller 24 (e.g., an Hitachi H8/300H microcontroller), a plurality of valves (e.g., seven, 3-way valves V1, V2, V3, V4, V5, V6 and V7), the temperature-controlled sensor module 100, a heated sample line 15, a sample (flue) gas manifold 26, an air manifold 28 and air gas flow 28A, a calibration gas path 30 and a pump 32. As will be explained in detail later, the system controller 24 controls the operation of the plurality of valves to effect, among other things, sensor calibration and continuous flue-component gas level detection. Calibration gas sources 14 are coupled to the calibration gas path 30 to provide the reference levels for gas calibration. A precision diluter 27 is coupled to the sample gas manifold 26 and dilutes the flue gas sample with instrument air whenever the presence of the component gases exceeds the upper detection limit of the electrochemical sensors.

The temperature-controlled sensor module 100 comprises at least one pair of electrochemical (EC) sensors. Each pair detects a particular component of the flue gas, such as but not limited to NO, NO₂, SO₂, CO or O₂. By way of example only, five pairs (also referred to as “channel pairs”) of sensors P1-P5 are shown in FIG. 1, with each EC sensor being designated as a “channel A” (S1A-S5A) or “channel B” (S1B-S5B) accordingly; a carbon dioxide (CO₂) sensor 34 is located outside of the temperature-controlled sensor module 100 and, unlike the other EC sensors, comprises an infrared bench using NDIR (non-dispersive infrared) technology; one example of such a carbon dioxide sensor uses a Vaisala GMM221M0N0A3A2A0A measuring head. It should be understood that the actual number of pairs of sensors may vary and the present invention is not limited by the number of pairs of sensors. By way of example only, the EC sensors (also referred to as “cells”) that may be used in the present invention are those sold by City Technology Ltd (United Kingdom) such as 2FO/5FO CiTiceL® (oxygen), 5F/5MF/A5F CiTiceL® (carbon monoxide), 5NF CiTiceL® (nitric oxide), 5ND CiTiceL® (nitrogen dioxide), and 5SF/F CiTiceL® (sulfur dioxide). These electrochemical cells are by way of example only and other conventional electrochemical cells can be used.

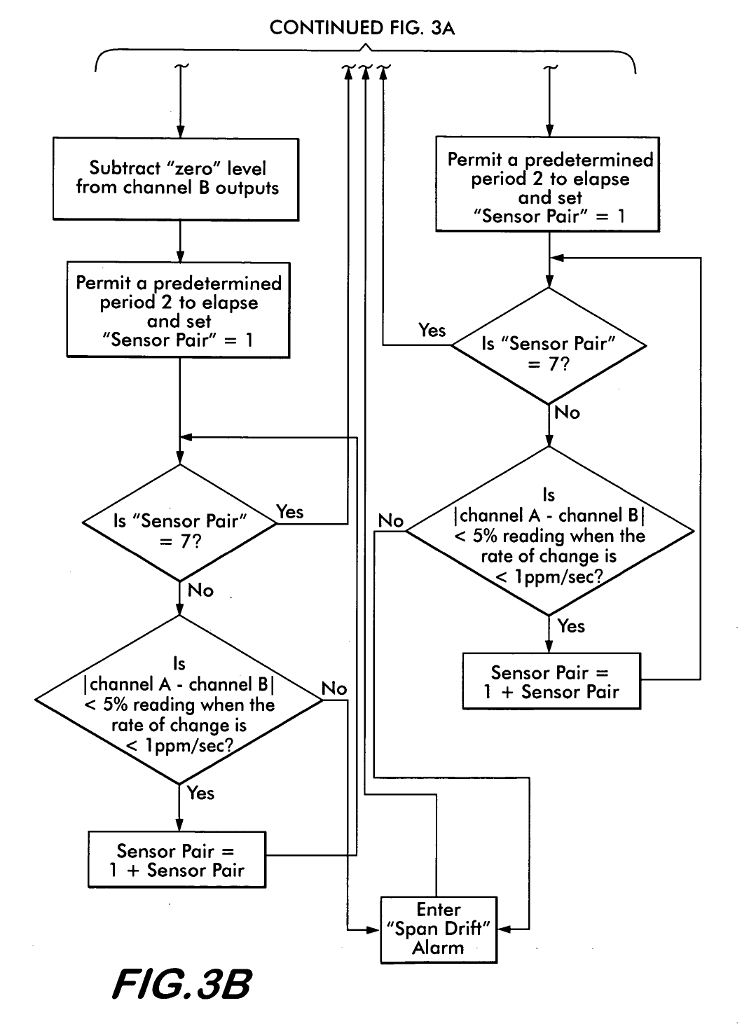

High levels of accuracy (e.g., 0.1 ppm) at low concentrations (0-10 ppm range) are achievable if the cell operating temperature is carefully controlled. Ideally, cell temperature must be fixed and maintained between 30° C.-40° C. with a control point set at ±0.1° C. Determination of the exact control temperature is set by the analyzer manufacturer. This is achieved efficiently by integrating the sensors with a heating and cooling unit 36 (e.g., a Marlow DT12-6) that is in direct contact with the housing and which uses thermoelectric heating and cooling. To overcome the problems of condensation in hot, humid environments, the sensor module 100 is continuously purged with clean dry air. This air evaporates any condensation formed on the sensors while the access door 42 (FIG. 4) was open.

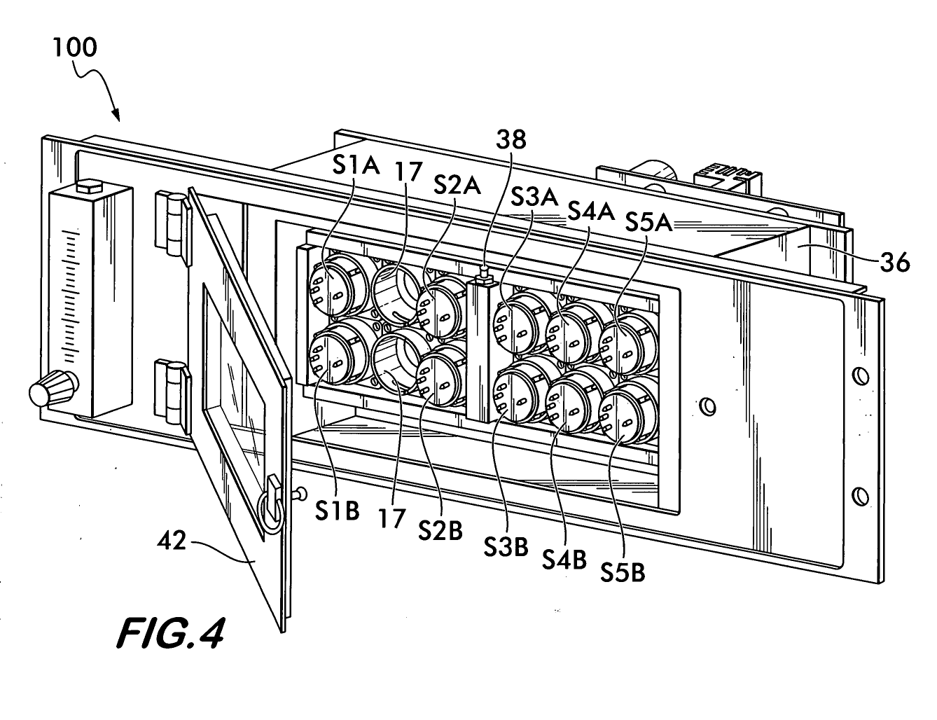

In addition, a thermistor 38 (see FIGS. 4-5, e.g., a Siemens B57703M103G thermistor) disposed in the sensor module 100 for providing a temperature signal to the system controller 24; thus, should the temperature deviate from the desired value, the system controller 24 can declare invalid component gas levels from the EC sensors S1A-S5B until the temperature is once again stabilized in the appropriate range.

A portion of the flue gas 8 is diverted through a sample probe 12 that pre-conditions the diverted flue gas 8. This cleaned, dried and cooled sample flue gas flow 15 is fed to the pump 32 before entering the gas manifold 26. As will be explained in detail later, each sensor S1A-S5B is fed at intervals with sample flue gas and then air according to the method of the present invention. Each sensor S1A-S5B, and CO₂ sensor 34, generates an electrical output in proportion to a specific flue gas component which is transmitted to the system controller 24. After an analog-to-digital conversion (ADC) stage, the sensor outputs are processed by the controller 24 and the corresponding gas concentrations are transmitted to a user interface 16 for display to the operator. The NOₓ concentration level is calculated by the system controller 24. The carbon dioxide sensor 34 is fed by the sample flue gas manifold 26 but not by the air. The sample flue gas flow 15 and air flow 28A are exhausted through an exhaust path 40.

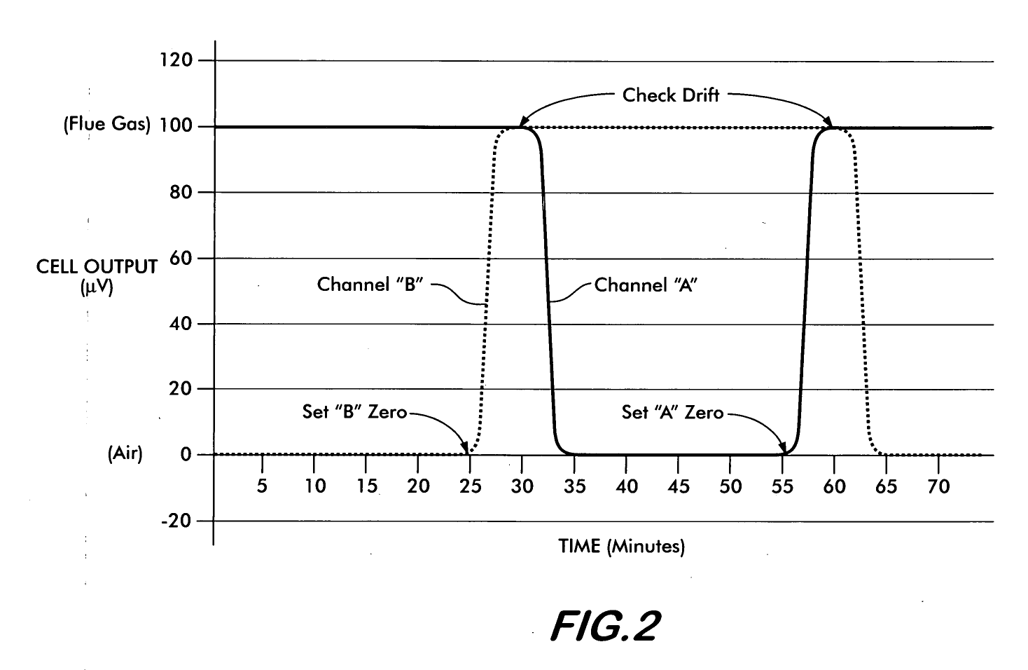

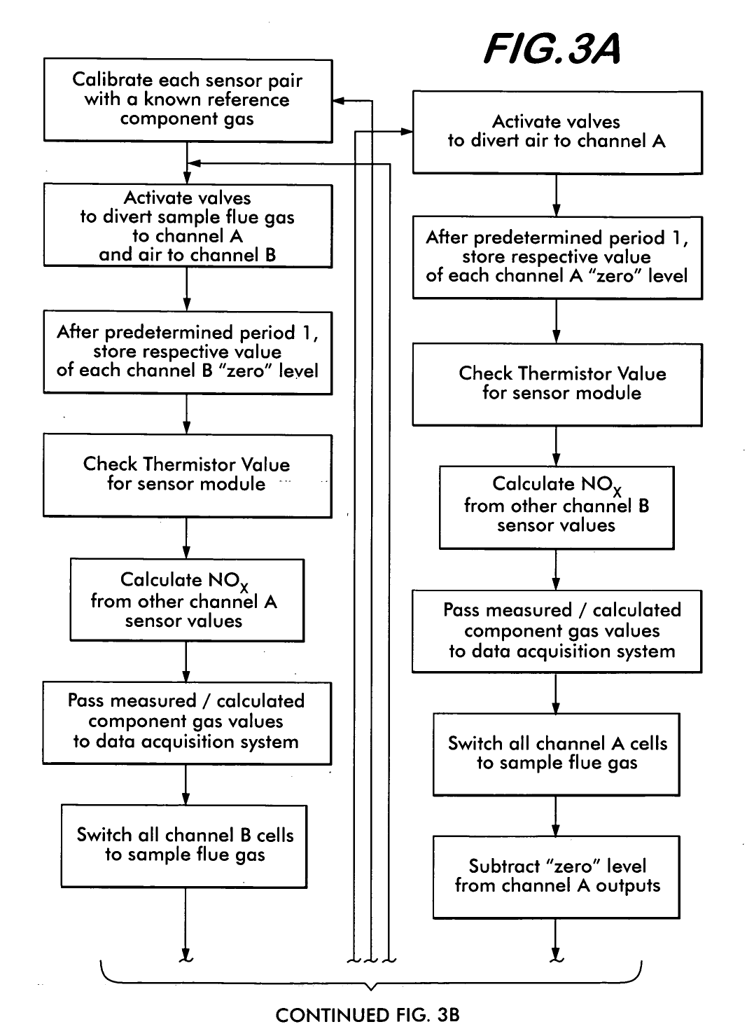

As mentioned earlier, the cells S1A-S5A in each pair P1-P5 are used alternately, where the valve switching is managed by the system controller 24, so that a continuous uninterrupted output is produced. FIG. 2 shows how this works. The outputs from the two EC cells in a pair are shown as channel A (solid line) and channel B (dotted line) in FIG. 2. FIGS. 3A-3B provide a flow chart of the system controller 24 operation.

As shown in FIG. 2, at time 0, the system controller 24 activates valves V1, V3, and V5 such that channel A cells are flowing flue gases, and wherein the channel A cells produce outputs calibrated to a known value. Simultaneously, the system controller 24 activates valves V2, V4 and V6 such that the channel B cells are flowing air and produce outputs calibrated to a zero value.

The following discussion concerns one pair of sensors, namely, P1 for channel A (S1A) and channel B (S1B), it being understood that all channel As and all channel Bs operate similarly. After a predetermined (but adjustable, dependent upon application) duration (e.g., 25 minutes referred to as “predetermined period 1” in FIG. 3A), the channel B cell has had time to settle to its zero level, and the output voltage of channel B cell is recorded as its zero offset. This voltage is subtracted from all subsequent channel B cell readings, to eliminate any offset. Next, the system controller 24 then activates valve V2 to allow flue gases to flow from the sample flue gas flow 15 to the channel B cell, and so its output rapidly rises to the same level as the channel A cell. A predetermined duration (e.g., approximately 5 minutes referred to as “predetermined period 2” in FIG. 3B) is set to ensure that the channel B cell has settled to its final value, and then the outputs from the two cells (i.e., channel A and channel B) are compared. If the outputs differ by more than 5% of reading (defined as a “window”), when the rate of change is less than 1 ppm/sec, a “span drift” fault is indicated by the system controller 24. If, on the other hand, the outputs are within the window, the system controller 24 then activates valve V1 to switch the channel A cell over from flue gas to air and repeats the previous process of zeroing and “refreshing” the cell. This process continues until a calibration check is initiated. The calibration check is performed at regular intervals, typically every 24 hours.

At time of a calibration check, the EC cells S1A-S5B, have calibration gas flowed simultaneously via calibration gas path 30 from calibration gas sources 14 to ensure a good calibration with an output value averaged between the two cells of any pair. If a multi-gas analyzer is being calibrated, a built-in cross-sensitivity check is used in the calibration cycle where appropriate.

The present invention 20 automatically corrects any zero-drift and detects any span drift. The switching process also ensures that the oxygen and water content of the electrolytes in the cells are kept correctly balanced, thereby extending cell lifetimes with high accuracy.

It should be noted that in the step where the system controller 24 checks the thermistor value, if the system controller 24 detects that the module temperature is outside the range of 30° C.-40° C., then the system controller 24 can declare a system fault.

FIG. 4 depicts an isometric view of the temperature-controlled sensor module 100 with an insulated sensor access door 42 shown in an opened condition. The five sensor pairs P1-P5 can be seen with their printed circuit cards (to be discussed later) omitted for clarity; these printed circuit cards provide the interface between the EC cells and the system controller 24. Also omitted for clarity is the sensor pair between sensor pair P1 and sensor pair P2; the EC receptacles depict how the EC cells are secured in the sensor module 100, which will also be discussed later. By way of example only, sensor pair P1 may comprise O₂ cells, sensor pair P2 may comprise CO cells, sensor pair P3 may comprise NO cells, sensor pair P4 may comprise NO₂ cells and sensor pair P5 may comprise SO₂ cells; the empty receptacles shown in FIG. 4 may comprise hydrogen sulfide (H2S) EC cells.

As mentioned earlier, to maintain the temperature within the sensor module 100, a thermoelectric heating/cooling unit 36 (FIG. 5) is directly coupled to the sensor module housing, preferably along its backside. In particular, the thermoelectric heating/cooling unit 36 (e.g., Peltier heat pump) comprises a temperature controller 36A, fan 36B and heat exchanger 36C. Together, these components provide the precise temperature control for the EC cells inside the sensor module 100.

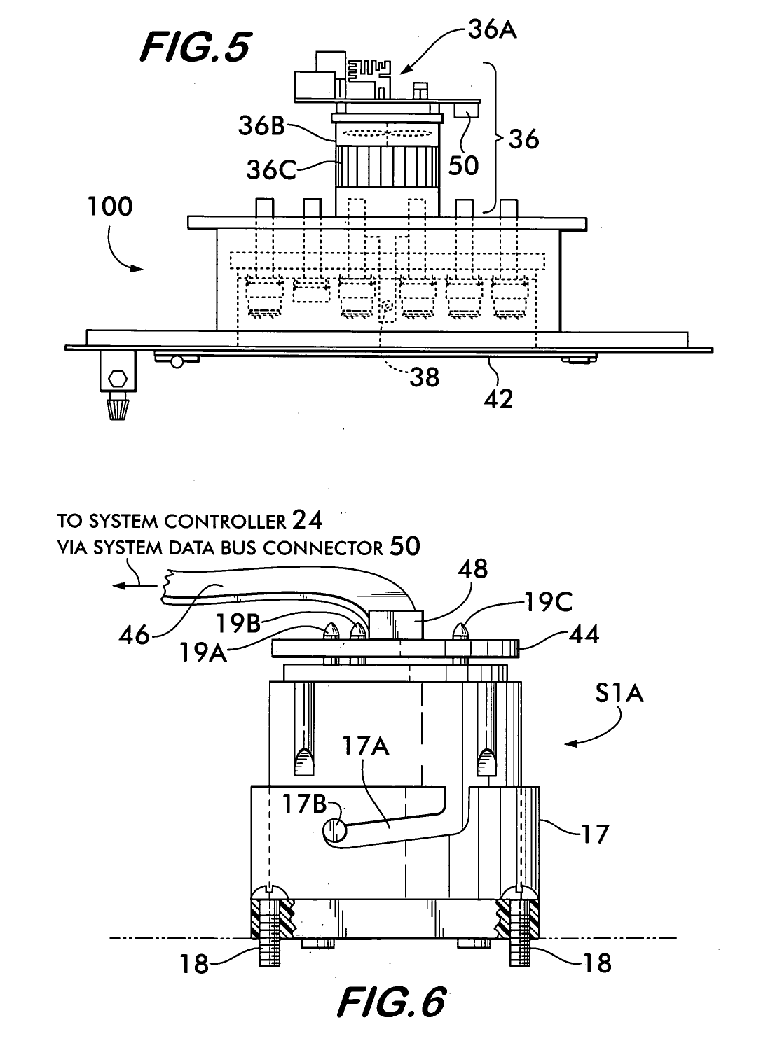

As shown most clearly in FIG. 6, each EC cell (e.g., S1A) is releasably secured within the temperature-controlled sensor module 100 using a bayonet-clip holder 17. This allows each EC cell to be quickly replaced when necessary. The holder 17 basically comprises a pair of opened slots (only one of which, 17A, is shown) on opposite sides of the holder 17 for receiving corresponding pins (only one of which, 17B, is shown) located on opposite sides of the EC cell therein. To remove an EC cell, the technician need only rotate the EC cell counterclockwise and pull up; conversely, to install a new EC cell, the technician need only align the corresponding pins 17B with the opening in the slot 17A, push down and then rotate the EC cell clockwise. The holder 17 is releasably secured to the back wall of the temperature controlled sensor module 100 using any conventional fasteners, e.g., screws 18.

Electrical communication of the EC cell output is accomplished using circuit card 44 that is push fit onto electrical output pins (three of which, 19A-19C) of the EC cell. Although not shown, this circuit card 44 comprises an amplifier, filter and bias circuit for amplifying/filtering the EC cell output. The electrical output is provided to the system controller 24 over a ribbon cable 46. The cable 46 is electrically coupled to the circuit card 44 via a connector 48; although not shown, the other end of the ribbon cable 46 is connected to the sensor unit mother board. There it is converted to digital format and transmitted to the system controller 24 over the system data bus. Thus, to replace an EC cell, the circuit card 44 needs to be disengaged from the EC cell electrical output pins and then the EC cell can be removed from 10 the holder 17, as described above; the technician can then install a new EC cell in the holder 17 and then re-connect the circuit card 44 to the electrical output pins of the new EC cell.

As mentioned earlier, the present invention 20 allows measurement down to very low levels (0.1 ppm resolution), giving performance commensurate with the proposed changes in environmental legislation. The automatic zero correction and predetermined time base cross-check of flue gas component concentrations, continuously ensure system measurement integrity. In addition, electrochemical technology allows the end user to determine NOₓ without the use of thermal-oxidizers. By eliminating the conversion loss, of NO to NO₂ due to thermal-oxidizer inefficiencies, and actually measuring NO and NO₂ discriminately, the accuracy ofNOₓ (NO+NO₂) is improved.

The use of electrochemical ADST technology is very accurate and stable for low level (as well as high level) gas concentrations, thus providing an alternative, low cost method on compliance monitoring.

While the invention has been described in detail and with reference to specific examples thereof, it will be apparent to one skilled in the art that various changes and modifications can be made therein without departing from the spirit and scope thereof.

1. An emissions monitoring system for continuously monitoring the level of component gases in flue gas, said system comprising:
a temperature-controlled sensor module;
at least two electrochemical sensors for measuring the concentration of a predetermined component gas, said at least two electrochemical sensors being disposed in said temperature-controlled sensor module;
valves for directing the flow of flue gas and air to said at least two electrochemical sensors;
a controller for controlling the valves such that said at least two electrochemical sensors are alternately exposed to the flue gas and to air wherein one of said at least two electrochemical sensors is providing a measurement of the concentration of the predetermined component gas and another one of said at least two electrochemical sensors is recalibrated with reference to clean ambient air.

2. The emission monitoring system of claim 1 wherein said temperature-controlled sensor module comprises a thermoelectric heating/cooling unit to maintain the temperature within said temperature-controlled sensor module.

3. The emission monitoring system of claim 2 wherein said thermoelectric heating/cooling unit maintains the temperature within said temperature-controlled sensor module to approximately 30° C.-40° C.

4. The emission monitoring system of claim 2 wherein said thermoelectric cooling unit comprises an access door and wherein said thermoelectric cooling unit maintains a flow of dry air to evaporate any condensation formed on the sensors while said access door was open.

5. The emission monitoring system of claim 1 wherein said at least two electrochemical sensors provide the level of said predetermined component gas as low as 0.1 ppm.

6. The emission monitoring system of claim 1 wherein the predetermined component gas can be NO, NO₂, SO₂, CO or O₂.

7. The emission monitoring system of claim 1 wherein said controller controls said valves to allow both of said at least two sensors to detect the concentration of the predetermined component gas simultaneously for a predetermined period of time to form two respective outputs, said two respective outputs being compared by said controller.

8. The emission monitoring system of claim 8 wherein said controller provides an alert if said two respective outputs differ from each other by a predetermined amount.

9. A sensor assembly for continuously detecting the concentration of component gases in flue gas, said sensor assembly comprising:
a temperature-controlled sensor module;
at least two electrochemical sensors for measuring the concentration of a predetermined component gas, said at least two electrochemical sensors being disposed in said temperature-controlled sensor module and being alternately exposed to the flue gas and to air so that one of said at least two electrochemical sensors is providing a level of the predetermined component gas and another one of said at least two electrochemical sensors is recalibrated with reference to clean ambient air.

10. The sensor assembly of claim 9 wherein said temperature-controlled sensor module comprises a thermoelectric heating/cooling unit to maintain the temperature within said temperature-controlled module.

11. The sensor assembly of claim 10 wherein said thermoelectric heating/cooling unit maintains the temperature within said temperature-controlled sensor module to approximately 30° C.-40° C.

12. The sensor assembly of claim 9 wherein said at least two electrochemical sensors provide the level of said predetermined component gas as low as 0.1 ppm.

13. The sensor assembly of claim 9 wherein the predetermined component gas can be NO, NO₂, SO₂, CO or O₂.

14. A method for continuously monitoring the concentration of component gases in flue gas, said method comprising the steps of:
providing at least two electrochemical sensors for measuring the concentration of a predetermined component gas;
alternately exposing one of said at least two electrochemical sensors to the flue gas and another one of said at least two electrochemical sensors to air.

15. The method of claim 14 further comprising the step of maintaining the temperature of said at least two electrochemical sensors between approximately 30° C.-40° C.

16. The method of claim 14 wherein said step of maintaining the temperature comprises using thermoelectric heating and cooling.

17. The method of claim 15 wherein said at least two electrochemical sensors measure the concentration of the predetermined component gas as low as 0.1 ppm.

18. The method of claim 14 wherein said step of alternately exposing one of said at least two electrochemical sensors comprises:
intermittently allowing both of said at least two sensors to detect the level of the predetermined component gas simultaneously for a predetermined period of time to form two respective outputs; and
comparing said two respective outputs to determine if they are within a predetermined window.

19. The method of claim 18 wherein said predetermined window comprises less than 5% of reading when the rate of change is less than 1 ppm/sec.
